(19) United States
(12) Patent Application Publication
(10) Pub. No.: US 2003/0221976 A1
(43) Pub. Date: Dec. 4, 2003

(54) Device for determining the ozone conversion rate of an ozone conversion element which is coated with a catalyst material

(76) Inventors: Joerg Friedel, Wenzenbach/Gruenthal (DE); Anton Grabmaier, Zeitlarn (DE); Hans-Peter Gottler, Regensburg (DE); Alexander Sommer, Mitterteich (DE)

Correspondence Address: Kevin R. Spivak, Morrison & Foerster LLP, Suite 300, 1650 Tysons Boulevard, McLean, VA, 22102, US

(21) Appl. No.: 10/351,581

(22) Filed: Jan. 27, 2003

(30) Foreign Application Priority Data
Jan. 28, 2002 (DE) 10203223.8

(51) Int. Cl. G01N 27/26

(52) U.S. Cl. 205/784.5; 205/785.5; 204/431

(57) ABSTRACT

A device for determining the ozone conversion rate of an ozone conversion element which is coated with a catalyst material, in particular of a radiator in a motor vehicle. The device having a first air-guidance passage and a second air-guidance passage for receiving air upstream and downstream of the ozone conversion element, the air-guidance passages being connected via a switching device to a third air-guidance passage, in which an ozone sensor element is arranged. By means of the switching device, either the airstream upstream of the ozone conversion element or the airstream downstream of the ozone conversion element can be passed to the ozone sensor element.

### CLAIM FOR PRIORITY

This application claims priority to Application No. 10203223.8 which was filed in the German language on Jan. 28, 2002.

### TECHNICAL FIELD OF THE INVENTION

The invention relates to a device for determining the ozone conversion rate of an ozone conversion element which is coated with a catalyst material.

### BACKGROUND OF THE INVENTION

For reasons of environmental and personal protection, the level of pollutants which results from motor vehicles with an internal combustion engine or from the generation of energy using stationary combustion facilities needs to be reduced.

A relatively new approach aimed at reducing the levels of pollutants includes actively removing pollutants not directly from the exhaust-gas stream from a combustion facility but rather from the ambient air. This approach is promising, in particular, for the removal of groundlevel ozone, which has a considerable influence on human health on account of its strongly oxidizing action. Ozone itself it is not a gas which is emitted directly, and therefore cannot be removed in the exhaust-gas stream. Rather, it is formed when nitrogen oxides are present in outside air under solar irradiation, on account of the UV component thereof resulting from complex photochemical reaction equilibria.

Since ozone is extremely reactive, it can easily be quantitatively broken down by means of a catalyst system through which air flows These catalysts are extremely stable, since there is no need for direct action from strong oxidation catalysts, which are highly sensitive to poisoning, such as for example platinum. Systems which substantially effect adsorption of the ozone on a surface are sufficient to achieve the desired effect; this ozone then instantaneously breaks down to form oxygen.

Such catalyst systems have long been used in passenger aircraft which fly close to the ozone layer. In this case, they are used to treat the air which is passed into the passenger compartment. Recently, such systems have also started to be used in motor vehicles. In this application, the radiator of the vehicle is coated with the catalyst. The air which flows through the radiator in large quantities has ozone quantitatively removed, i.e. the vehicle purifies the ambient air.

A system of this type represents a component which is relevant to the exhaust gas. In increasing numbers of countries, the respective legislatures prescribe an on-board diagnosis unit for all components which are relevant to the exhaust gas. Therefore, a corresponding sensor system is also required for an ozone-removal system.

For this application area, it is advantageously possible to use thin-film gas sensors based on metal oxide. Sensors of this type are technologically advanced and have long proven useful in a wide range of different technical applications. One example of a gas sensor of this type is described in DE 199 24 083 A1.

According to German application numbers 101 07 169.8 and 101 42 711.5, a possible sensor system comprises at least two ozone sensor elements, at least one of which is arranged upstream of a catalyst-coated ozone conversion element in an airstream and at least one of which is arranged downstream of a catalyst-coated ozone conversion element in an airstream. The ratio of the ozone values determined is a measure of the ozone conversion rate, so that it can be used to determine the ability of the ozone conversion element to function.

However, the ozone sensor elements described have production-related differences from one another and on account of their complex layer structure and the associated production outlay, are relatively expensive.

### SUMMARY OF THE INVENTION

The invention provides a device for determining the ozone conversion rate of an ozone conversion element which is coated with a catalyst material, and a method for operating a device of this type, which avoids the measurement inaccuracies resulting from differences between components and entails lower costs.

In one embodiment of the invention, there is a device for determining the ozone conversion rate of an ozone conversion element which is coated with a catalyst material, in particular of a radiator in a motor vehicle, having a first air-guidance passage and a second air-guidance passage for receiving air upstream and downstream of the ozone conversion element, the air-guidance passages being connected via a switching device to a third air-guidance passage, in which an ozone sensor element is arranged, so that by the switching device either the airstream upstream of the ozone conversion element or the airstream downstream of the ozone conversion element can be passed to the ozone sensor element.

In this device, the switching device is actuated such that air upstream of the ozone conversion element is passed through the first air-guidance passage to the ozone sensor element, and then air downstream of the ozone conversion element is passed through the second air-guidance passage to the ozone sensor element, and the conversion level of the catalyst coated ozone conversion element is determined from the ratio of the ozone concentration values which have been determined by the ozone sensor element. The degree of conversion determined can be used to trigger a warning signal, for example by monitoring whether it is within a prescribed range and by illuminating an indicator light if the degree of conversion lies below a minimum value.

The switching between the two air-guidance passages by the switching device has the result that one ozone sensor element is required, which is less expensive and avoids measurement inaccuracies resulting from production-related differences between various sensor elements.

In another embodiment of the invention, the switching device is designed with a passage switcher, which either, in a first position, connects the first air-guidance passage to the third air-guidance passage or, in a second position, connects the second air-guidance passage to the third air-guidance passage. The passage switcher may, for example, be driven by a stepper motor which is advantageously actuated by a control unit. This control unit may, in a particularly advantageous way, be formed with a microprocessor and may also actuate the ozone sensor element. This microprocessor may also be part of an engine control unit.

In still another embodiment of the invention, the passage switcher, in a third position, separates the third air-guidance passage from both the first and the second air-guidance passage, so that in this position the airflow is interrupted and zero balancing of the sensor element is possible.

In yet another embodiment of the invention, the passage switcher is formed with at least one flap which can be moved into the air stream and can also be moved into an intermediate position, in which an air-guidance passage is partially opened or closed. As a result, on the one hand, by suitably setting the flap position, it is possible to achieve a constant air flow velocity at the sensor element and, on the other hand, at a high driving speed it is possible to prevent the sensor element from “blowing off”, a phenomenon in which the supplied power is no longer sufficient to establish the operating temperature.

In a further embodiment of the invention, the switching device is formed with valves, for example solenoid valves, which can be actuated by a control device and can be closed either as alternatives or simultaneously, so that in this solution too either the first air-guidance passage or the second air-guidance passage can be connected to the third air-guidance passage or the third air-guidance passage can be separated from the other two air-guidance passages, in order to carry out zero balancing of the sensor element.

### BRIEF DESCRIPTION OF THE DRAWINGS

The invention is explained in more detail below with reference to exemplary embodiments and with the aid of figures, in which:

FIG. 1 shows a first exemplary embodiment of a device according to the invention.

FIG. 2 shows a second exemplary embodiment of a device according to the invention.

### SUMMARY OF THE INVENTION

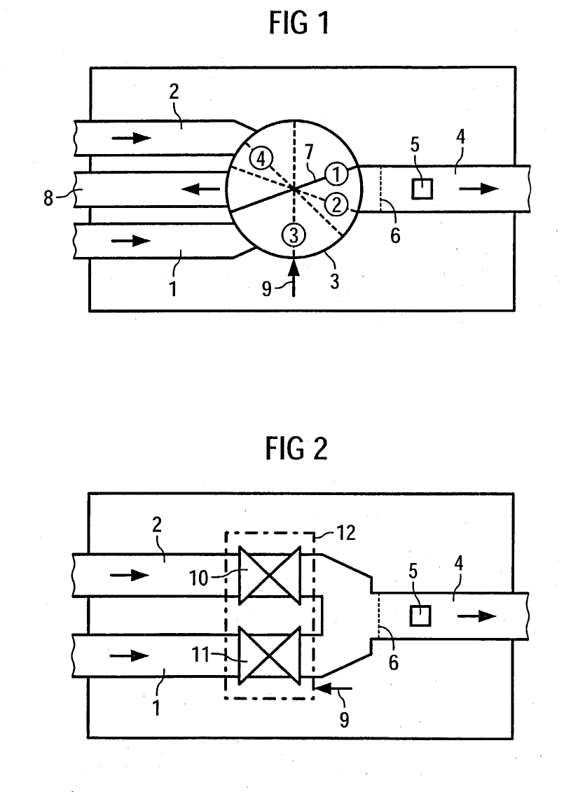

According to FIG. 1, a first air-guidance passage 1 and a second air-guidance passage 2 are connected to a third air-guidance passage 4 via a switching means 3. The first air-guidance passage 1 should carry air from a location upstream of a catalyst-coated ozone conversion element (not shown) and the second air-guidance passage 2 is intended to carry air from a location downstream of the ozone conversion element. The ozone conversion element is, for example, a radiator of a motor vehicle.

In the third air-guidance passage 4, there is an ozone sensor element 5, by means of which the current ozone concentration can be measured, i.e. the ozone concentration upstream or downstream of the ozone conversion element, depending on which air-guidance passage 1, 2 is currently connected to the third air-guidance passage. A diaphragm 6, which protects the ozone sensor element from contamination, is arranged upstream of the ozone sensor element 5, as seen in the direction of flow of the air.

The switching device 3 shown in FIG. 1 has a rotatable flap 7 which can be moved into a number of positions, for example by means of a stepper motor, three of which positions are illustrated by numbers “1” to “3” in circles in FIG. 1.

In the first position “1”, the first air-guidance passage 1 is connected to the third air-guidance passage 4, while air which is carried through the second air-guidance passage 2 is carried away from the switching device 3 through a fourth air-guidance passage 8. Accordingly, in position “2”, the second air-guidance passage 2 is connected to the third air-guidance passage 4.

In a third position “3”, the third air-guidance passage 4 is separated from the first and second air-guidance passages 1, 2, so that on the one hand the switching device 3 can be vented via the fourth air-guidance passage 8 and on the other hand ozone in the third air-guidance passage 4 can be converted on the hot sensor surface until there is no longer any ozone in the third air-guidance passage 4 and therefore zero balancing of the sensor element 5 is possible.

The actuation of the switching device 3 is indicated by an arrow 9 and is effected by a control unit (not shown), which is preferably formed with a microprocessor and which in addition is also able to supply the ozone sensor element 5 with thermal energy and to process the measurement signals from it. However, these aspects have already been extensively described in the applications mentioned above.

The flap 7 of the switching device 3 can also be moved into an intermediate position “4”, in which, in the example illustrated, the second air-guidance passage 2 is partially connected to the third air-guidance passage 4, so that the through flow of air is lower, in order, for example, to prevent the sensor element 5 from “blowing off” at high driving speeds. Moreover, by suitable actuation of the switching device 3, such intermediate positions allow a constant air speed to be achieved in the third air-guidance passage, so that the measurement of the ozone concentration takes place under identical conditions.

A further embodiment of a switching device 12 according to the invention is illustrated in FIG. 2. In FIG. 2, identical parts to those shown in FIG. 1 are provided with identical reference symbols and are not described again.

In the exemplary embodiment shown in FIG. 2, the switching device 12 is formed with valves 10, 11 which are arranged in the first and second air-guidance passages 1, 2 and are able to open and close the latter, so that either the first air-guidance passage 1 or the second air-guidance passage 2 is connected to the third air-guidance passage 4 or both air-guidance passages 1, 2 are separated from the third air-guidance passage 4, in order to allow zero balancing of the sensor element 5. This switching device 12 can also be actuated by a control device, which is again indicated by an arrow 9.

In both the devices for determining the ozone conversion rate of an ozone conversion element coated with a catalyst material which are illustrated in FIGS. 1 and 2, the conversion rate can be determined both by means of a one-off measurement of the ozone concentration upstream and downstream of the ozone conversion element or by forming a mean from a plurality of measurements.

What is claimed is:

1. A device for determining the ozone conversion rate of an ozone conversion element which is coated with a catalyst material, comprising:
a first air-guidance passage and a second air-guidance passage to receive air upstream and downstream of the ozone conversion element, the air-guidance passages being connected via a switching device to a third air-guidance passage, in which an ozone sensor element is arranged, wherein the switching device causes either the airstream upstream of the ozone conversion element or the airstream downstream of the ozone conversion element to be passed to the ozone sensor element.

2. The device as claimed in claim 1, wherein the switching device is configured as a passage switcher, which, in a first position, connects the first air-guidance passage to the third air-guidance passage and, in a second position, connects the second air-guidance passage to the third air-guidance passage.

3. The device as claimed in claim 2, wherein the passage switcher, in a third position, separates both the first air-guidance passage and the second air-guidance passage from the third air-guidance passage.

4. The device as claimed in claim 2, wherein the passage switcher is formed with at least one flap which can be moved into an intermediate position in which an air-guidance passage is partially opened or closed.

5. The device as claimed in claim 1, wherein the switching device is formed with actuable valves arranged in the first air-guidance passage and in the second air-guidance passage.

6. The device as claimed in claim 1, wherein a diaphragm is arranged in the third air-guidance passage upstream of the ozone sensor element.

7. The device as claimed in claim 1, wherein a control device actuates the switching device.

8. The device as claimed in claim 7, wherein the control device actuates the ozone sensor element.

9. A method for determining the ozone conversion rate of an ozone conversion element which is coated with a catalyst material, comprising:
actuating a switching such that air upstream of the ozone conversion element is passed through a first air-guidance passage to the ozone sensor element, and then air downstream of the ozone conversion element is passed through a second air-guidance passage to an ozone sensor element, and a degree of conversion of the catalyst-coated ozone conversion element is determined from a ratio of ozone concentration values which have been determined by the ozone sensor element.

10. The method as claimed in claim 9, wherein a warning device is activated if the degree of conversion determined is below a defined value.

11. The device as claimed in claim 3, wherein the passage switcher is formed with at least one flap which can be moved into an intermediate position in which an air-guidance passage is partially opened or closed.

12. The device as claimed in claim 1, wherein the conversion element is a radiator in a motor vehicle.
